(19) United States
(12) Patent Application Publication
(10) Pub. No.: US 2016/0203197 A1
(43) Pub. Date: Jul. 14, 2016

(54) Method and System for Automatic Management of Dynamically Allocated Memory in a Computing Unit

(71) Applicant: Huawei Technologies Co., Ltd., Shenzhen (CN)

(72) Inventors: Kumar Rajeev Rastogi, Bangalore (IN); Amit Kapila, Bangalore (IN); Dilip Kumar, Bangalore (IN); Yuanyuan Nie, Beijing (CN)

(21) Appl. No.: 15/079,309

(22) Filed: Mar. 24, 2016

Related U.S. Application Data
(63) Continuation of application No. PCT/CN2014/075668, filed on Apr. 18, 2014.

(30) Foreign Application Priority Data
Sep. 24, 2013 (IN) IN4329/CHE/2013

(51) Int. Cl. G06F 17/30

(52) U.S. Cl. CPC G06F 17/30563; G06F 17/30377

(57) ABSTRACT

A method and system for automatic management of dynamically allocated memory in a computer where the system comprises one or more client machines, a communication network and a computer. The one or more users provide one or more queries to access data from the computer and the client machines send the received queries to the computer through the communication network. The processor configured in the computer creates a heap record upon identifying the received queries to be at least one INSERT, DELETE and first type of UPDATE. The heap record is stored in data segment of the one or more databases and when the received queries is second type of UPDATE, the processor creates an undo record and stores the undo record in undo segment of the databases.

### CROSS-REFERENCE TO RELATED APPLICATIONS

This application is a continuation of International Application No. PCT/CN2014/075668, filed on Apr. 18, 2014, which claims priority to Indian Patent Application No. IN4329/CHE/2013, filed on Sep. 24, 2013, all of which are hereby incorporated by reference in their entireties.

### TECHNICAL FIELD

The present disclosure relates to database technologies. In particular, the present disclosure relates to a method and system for automatic management of dynamically allocated memory in a computing unit.

### BACKGROUND

Computer systems may manage computer memory dynamically. Dynamic memory management refers to the process by which blocks of memory are allocated temporarily for a specific purpose and then deallocated when no longer needed for that purpose. Deallocated blocks are available for reallocation for another purpose. The memory that the processing unit configured in the computer system manages is referred to as a “heap”. When a program/application needs a block of memory to store data, the program/application sends a request to the processing unit. The processing unit allocates a block of memory in the heap to satisfy the request and sends a pointer to the program/application. The program/application can then access the block of memory through the pointer.

The computer memory stores data in one or more databases. The data is related to one or more establishments such as financial institutions, commercial establishments, government offices, educational institutions, data security centers, weather forecast centers, manufacturing industries. The database can be a relational database, network database, object oriented database and hierarchical database. Generally, a relational database is a collection of relations (frequently referred to as tables). Relational databases use a set of mathematical terms, which may use structured query language (SQL) database terminology. For example, a relation may be defined as a set of tuples that have the same attributes. A tuple usually represents an object and information about that object. A relation is usually described as a table, which is organized into rows and columns. Generally, all the data referenced by an attribute are in the same domain and conform to the same constraints. The relational model specifies that the tuples of a relation have no specific order and that the tuples, in turn, impose no order on the attributes. Programs/applications read and write the data from the one or more databases by specifying queries, which use operations to identify tuples, identify attributes, and to combine relations. Similarly, queries may identify tuples for updating or deleting. When a row is updated, a new version of the row is created and inserted into the table. The new version occupies additional space in the heap. The previous version is provided a pointer to the new version. The previous version is marked expired, but remains in the database until it is collected by a garbage collector. Garbage collection is the process of dynamic memory management that detects and recovers the memory that is no longer accessible by the program/application. Thus, they can be used for deallocation and subsequent reallocation thereby increasing performance of the database.

One of the methods of improving the performance of the database is using multi-version concurrency control (MVCC). The aim of MVCC is to avoid the problem of writers writing data into the one or more databases blocking readers who are accessing the data from the one or more databases and vice-versa, by making use of multiple versions of data. The problem of writers blocking readers can be avoided if readers can obtain access to a previous version of the data that is locked by writers for modification. The problem of readers blocking writers can be avoided by ensuring that readers do not obtain locks on the data. For this purpose, MVCC allows multiple versions of data to exist and guarantees that the data is viewed consistently within a transaction and prevents interference between the transactions, readers and writers thus improving data concurrency. However, the disadvantage arises that for each transaction's duration, the size of the accessed data increases with each new version that is created, so there is a corresponding detrimental effect on performance.

In SQL, a VACCUM command must be run to manage the unnecessary areas created in the one or more databases due to the existence of multiple versions of data i.e for performing the garbage collection operation. This frees up the areas for reuse in other operations. Running the VACCUM command on regular basis also prevents the database from becoming too large. Unfortunately, the VACCUM command can be difficult to run in systems that run constantly, with the result that a lot of unnecessary areas are created in databases that are repeatedly added to or updated. This can also lead to the database file size becoming unreasonably large. FIG. 1 illustrates an existing method of allocating memory in a computing unit wherein multiple versions of data are created in order to improve the performance of the database. As an example, the processing unit receives the query from the client machine. The received query is as given below.
UPDATE suppliers
SET city=‘Santa Clara’
WHERE supplier_name=‘NVI’;
   The data related to suppliers is stored in the ‘SUPPLIERS’ Table. The ‘SUPPLIERS’ Table stores the data such as suppliers identifier (ID), suppliers name and city of the suppliers in the form of rows and columns as shown below.

| SUPPLIER_ID | SUPPLIER_NAME | CITY |
|---|---|---|
| 5001 | MS | New York |
| 5002 | BM | Chicago |
| 5003 | RH | Detroit |
| 5004 | NVI | A |

The processing unit identifies that the received query is related to UPDATE operation. The query is to set the city of the supplier named as NVI from ‘A’ to ‘Santa Clara’. The processing unit performs the UPDATE operation and the data is updated in the ‘SUPPLIERS’ Table as shown below.

TABLE 1
SUPPLIERS

| SUPPLIER_ID | SUPPLIER_NAME | CITY |
|---|---|---|
| 5001 | MS | New York |
| 5002 | BM | Chicago |
| 5003 | RH | Detroit |
| 5004 | NVI | Santa Clara |

Normally, the data related to all the Tables of the database 1 are stored as data segments which are illustrated in FIG. 1. The memory space 5001 to 5004 is allocated for the ‘SUPPLIERS’ Table i.e. the data related to all the suppliers is stored in this memory space. When the city is updated, a new version of the data is created. The new version is stored in the same data segment as shown in FIG. 1. The memory space 6001 is allocated for the new version of the data. Similarly, whenever there is a change in the data, the updated data or the deleted data is stored in the same data segment.

The limitation with the scenario illustrated in FIG. 1 is that, whenever the garbage collector performs garbage collection, it has to process extra rows in the data segment to detect and recover the memory space which is no longer utilized by any program/application. Because of the extra processing of new version of data, VACUUM, alternatively referred as garbage collector, performance as well as input/output (I/O) gets affected.

Further, if the query received by the processing unit is ROLLBACK, the processing unit has to perform many undo records in order to complete the rollback/recovery. While replaying the UNDO for INSERT/DELETE is kind of complete reverse operation of actual operation, which might be a costly operation and time consuming. Therefore, with more number of operations in the same transaction, more number of UNDO and hence more time to do the rollback operation. Hence, the rollback performance also goes down.

Hence, there exists a need for a method and system for automatic management of dynamically allocated memory in a computing unit by which the performance of the garbage collector is improved and also the performance of rollback and recovery is improved.

### SUMMARY

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

The present disclosure provides a method for automatic management of dynamically allocated memory in a computing unit. The method comprises receiving one or more queries by a processing unit, wherein the processing unit is configured to perform an operation on one or more databases in response to the received one or more queries. Upon receiving the one or more queries the processing unit determines whether the received one or more queries are related to at least one of INSERT, DELETE and first type of UPDATE. If the received one or more queries are related to at least one INSERT, DELETE and first type of UPDATE then the processing unit creates a heap record for a predetermined set of data stored in the one or more databases. If the received one or more queries is related to a second type of UPDATE then the processing unit creates an UNDO record for the predetermined set of data stored in the one or more databases.

The present disclosure provides a system for automatic management of dynamically allocated memory in a computing unit. The system comprises a memory unit configured to store one or more databases and a processing unit communicatively coupled to the memory unit. The processing unit receives one or more queries and performs an operation on the one or more databases based on the received one or more queries. The processing unit creates a heap record for a predetermined set of data stored in the one or more databases upon identifying the received one or more queries to be at least one of INSERT, DELETE and a first type of UPDATE and creates an undo record for the predetermined set of data stored in the one or more databases upon identifying the received one or more queries to be a second type of UPDATE.

The present disclosure is related to a non-transitory computer readable medium including operations stored thereon that when processed by at least one processing unit cause a system to receive one or more queries and perform an operation on one or more databases, stored in a memory unit, in response to the received one or more queries. Upon receiving the one or more queries, a heap record is created for a predetermined set of data stored in the one or more databases upon determining the received one or more queries to be at least one of INSERT, DELETE and a first type of UPDATE and an undo record is created for the predetermined set of data stored in the one or more databases upon determining the received one or more queries to be a second type of UPDATE.

The present disclosure provides a computer program for automatic management of dynamically allocated memory in a computing unit. The compute program comprises a code segment for receiving one or more queries, code segment for performing an operation on one or more databases based on the received one or more queries, code segment for creating a heap record for a predetermined set of data stored in the one or more databases upon determining the received one or more queries to be at least one of INSERT, DELETE and a first type of UPDATE and a code segment for creating an undo record for the predetermined set of data stored in the one or more databases upon determining the received one or more queries to be a second type of update.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 illustrates a block diagram of data segment in accordance with an embodiment of the prior art;

FIG. 2 illustrates a system block diagram in accordance with an embodiment of the present disclosure;

FIGS. 3A-3B shows block diagram of the database 1 in accordance with an exemplary embodiment of the present disclosure;

FIGS. 4A-4B shows the block diagram of the database 2 in accordance with an exemplary embodiment of the present disclosure; and

FIG. 5 shows a flowchart illustrating method for automatic management of dynamically allocated memory in a computing unit.

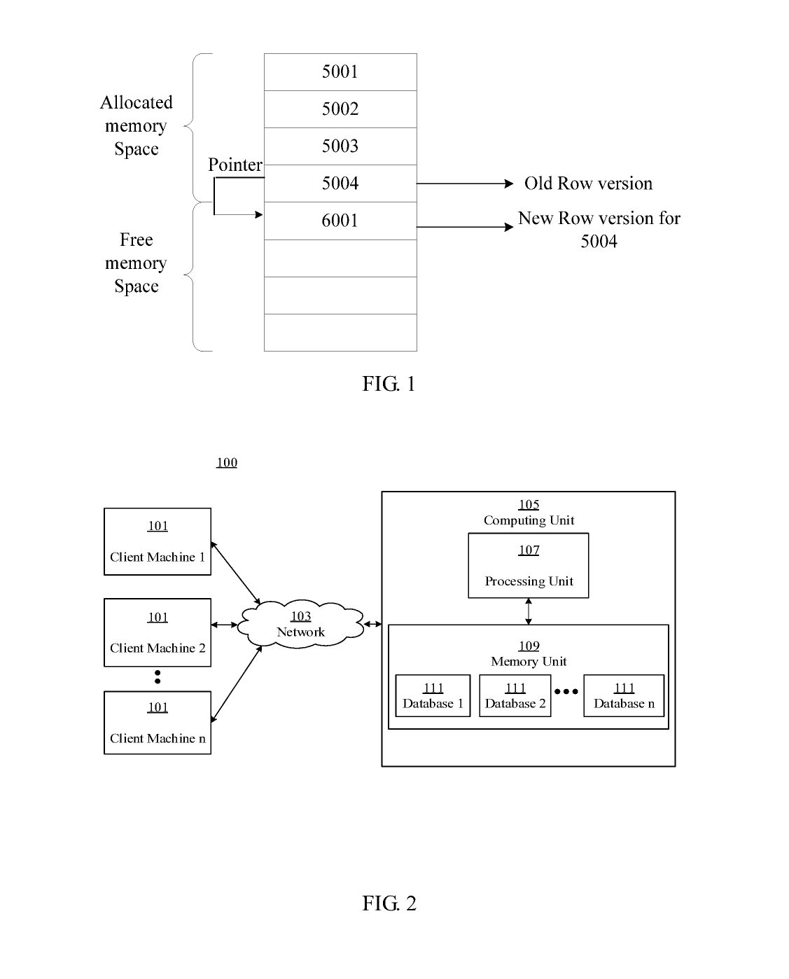

The figures depict embodiments of the disclosure for purposes of illustration only. One skilled in the art will readily recognize from the following description that alternative embodiments of the structures and methods illustrated herein may be employed without departing from the principles of the disclosure described herein.

### DESCRIPTION OF EMBODIMENTS

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The present disclosure is related to a method and system for automatic management of dynamically allocated memory in a computing unit. The processing unit receives one or more queries from the one or more client machines through the communication network. If the received one or more are related to at least one of INSERT, DELETE and first type of UPDATE, the processing unit creates a heap record and stores the heap record in the data segment of the one or more databases. If the received one or more queries are related to second type of UPDATE, the processing unit creates an undo record and stores the undo record in the undo segment of the one or more databases. For the second type of UPDATE the undo record is created because in the second type of UPDATE the updated data occupies more memory space in the data segment than the data before performing the UPDATE operation. Therefore, whenever the second type of UPDATE is received the undo record is created, wherein the new version of the data is stored in the data segment and the old version of the data is stored in the undo segment. Hence, whenever the garbage collector performs the garbage collection operation, it has less number of rows to be processed in the data segment thereby improving the performance of the garbage collector.

As used herein, the terms “INSERT” refers to adding rows to an existing Table, “UPDATE” refers to modifying set of existing Table rows, “DELETE” refers to removing existing rows from a Table, “first type of UPDATE” refers to modifying set of existing Table rows wherein the modified Table rows occupies memory space in the data segment which is same when compared to the memory space occupied by the Table rows before modification, “second type of UPDATE” refers to modifying set of existing Table rows wherein the modified Table rows occupies memory space in the data segment which is more when compared to the memory space occupied by the Table row before modification.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

FIG. 2 illustrates an exemplary system 100 block diagram in accordance with an embodiment of the present disclosure. The system 100 performs automatic management of dynamically allocated memory in a computing unit. The system 100 comprises one or more client machines 101, client machine 1 101 to client machine n 101, a communication network 103 and a computing unit 105. The one or more client machines 101 are associated to one or more users using which the one or more users provide queries and retrieve results from the computing unit 105. The one or more queries are generated using a query language including, but are not limited to, a multidimensional expressions (MDX) language and a SQL. The one or more client machines 101 include, but are not limited to, a mobile device, contactless device, computer, personal digital assistants (PDA), and any other communication devices capable of receiving input from the users, performing data transmission and displaying. In an embodiment, the one or more users use the one or more client machines 101 for accessing the data from the computing unit 105. The communication network 103 includes, but is not limited to, an electronic commerce (e-commerce) network, a peer to peer (P2P) network, local area network (LAN), wide area network (WAN) and any wireless network such as Internet and WIFI etc. The communication network 103 enables the one or more users (using the one or more client machines) to access the data from the computing unit. The computing unit 105 comprises a processing unit 107 and a memory unit 109. The memory unit 109 stores the data in one or more databases 111. The one or more databases 111 are managed using a relational database management system. The relational database stores the data in two-dimensional Tables. A Table is a two-dimensional structure made up of rows (tuples, records) and columns (attributes, fields). In an embodiment, the computing unit 105 might be a central server which stores data related to one or more establishments. The one or more establishments, includes, but are not limited to, financial institutions, stocks, commercial establishments, government offices, data security centers, social networks, educational institutions, weather forecast centers and manufacturing industries. As an example, the database 1 111 may store information relating to students, teachers, lecturers, subjects, marks, academic details etc. which falls under educational institutions, the database 2 111 may store information related to stocks, materials, invoices, customers, deliverables etc. which falls under financial institutions and database n 111 may store information related to social networks such as number of users in the network, names of all the users, login id of the users, number of posts made by each user etc.

In an embodiment, the one or more users provide queries using the one or more client machines 101. The one or more client machines 101 send the one or more queries to the computing unit 105 through the communication network 103. Alternatively, the user of the computing unit 105 may provide one or more queries through the user interface. The processing unit 107 receives the one or more queries and performs an operation on predetermined set of data stored in the one or more databases 111. If the received one or more queries is related to INSERT operation, the processing unit 107 writes the data in the one or more databases 111. If the received query is related to DELETE operation, the processing unit 107 deletes the data from the one or more databases and if the received one or more queries is related to UPDATE operation, the processing unit 107 updates the data stored in the one or more databases 111.

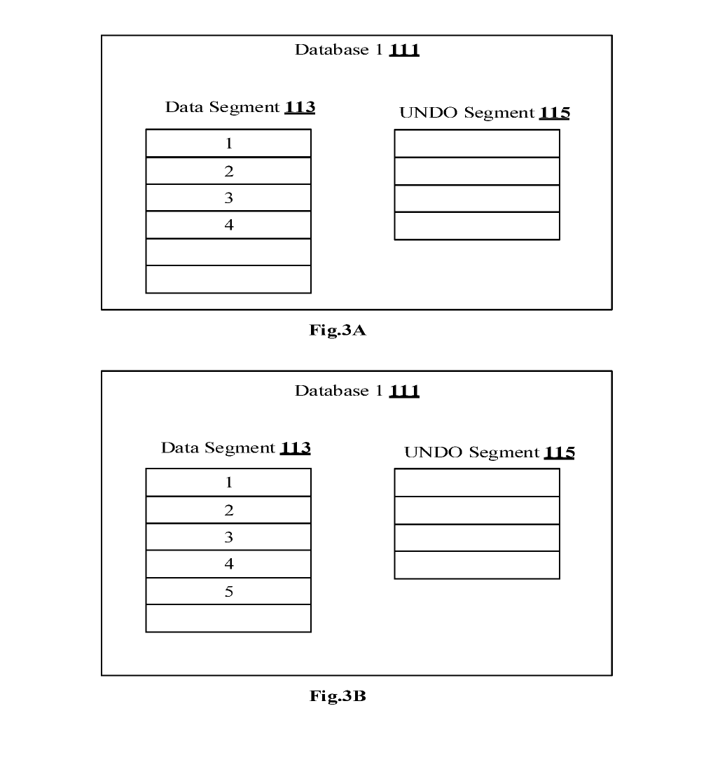

In an embodiment, if the received one or more queries is at least one of INSERT, DELETE and first type of UPDATE alternatively referred as in-place update then the processing unit 107 creates a heap record for the predetermined set of data stored in the one or more databases 111. If the received query is a second type of UPDATE alternatively referred as out-place update then the processing unit 107 creates undo record for the predetermined set of data stored in the one or more databases 111. The heap record is stored in the data segment 113 of the one or more databases 111, as shown in FIG. 3A and the undo record is stored in the undo segment 115 of the one or more databases 111, as shown in FIG. 3A. In the heap record, the new version of the data and the old version of the data are stored in the data segment 113 whereas in the undo record the new version of the data is stored in the data segment 113 and the old version of the data is stored in the undo segment 115. The first type of UPDATE is a type of UPDATE wherein upon performing the UPDATE operation, the new version of the data occupies same memory space as the old version of the data in the data segment 113 of the database 111. In the second type of UPDATE, upon performing the UPDATE operation, the new version of the data occupies more memory space than the old version of the data.

In an exemplary embodiment, the database 1 111 stores information related to educational institution, the database 2 111 stores information related to financial institution and the database n 111 stores the information related to social networking. The databases 1, 2 and n stores the data in the form of Tables i.e database 1 111 stores information related to educational institution in a Table named as ‘SCHOOL’, the database 2 111 stores information related to financial institution in a Table named as ‘FINANCE’ and the database n 111 stores information related to the social networking in a Table named as ‘NETWORK’. The Table ‘SCHOOL’ stores information related to the school such as student ID, student name and nationality of the student as shown below. The Table ‘FINANCE’ stores information related to such as supplier ID, supplier name and city of supplier as shown below and the Table ‘NETWORK’ stores information related to social networking such as user ID, user name and the number of posts made by each user as shown below.

TABLE 2
SCHOOL

| STUDENT_ID | STUDENT_NAME | NATIONALITY |
|---|---|---|
| 1 | ABC | INDIA |
| 2 | EFG | AMERICA |
| 3 | HIJ | AUSTRALIA |
| 4 | XYZ | SRI LANKA |

TABLE 3
FINANCE

| SUPPLIER_ID | SUPPLIER_NAME | CITY |
|---|---|---|
| 5001 | MS | New York |
| 5002 | BM | Chicago |
| 5003 | RH | Detroit |
| 5004 | NVI | Santa Clara |

TABLE 4
NETWORK

| USER_ID | USER_NAME | NUMBER OF POSTS |
|---|---|---|
| 11 | SHWE | 1 |
| 12 | RAM | 2 |
| 13 | SRA | 3 |
| 14 | MAD | 4 |

The user using the client machine 1 101 wishes to modify the data stored in the database 1 111. The user sends a query as shown below in order to perform the INSERT operation on the Table ‘SCHOOL’.
INSERT INTO SCHOOL
(STUDENT_ID, STUDENT_NAME, CITY)
VALUES
(5, ‘LMN’, NEW ZEALAND)

The processing unit 107 identifies that the received query is related to INSERT operation. The processing unit 107 updates the ‘SCHOOL’ Table based on the received query. The updated ‘SCHOOL’ Table is as shown below.

TABLE 5
SCHOOL

| STUDENT_ID | STUDENT_NAME | NATIONALITY |
|---|---|---|
| 1 | ABC | INDIA |
| 2 | EFG | AMERICA |
| 3 | HIJ | AUSTRALIA |
| 4 | XYZ | SRI LANKA |
| 5 | LMN | NEW ZEALAND |

FIGS. 3A-3B shows block diagram of the database 1 111 in accordance with an exemplary embodiment of the present disclosure. FIG. 3A shows the block diagram of the database 1 111 which stores the data related to the ‘SCHOOL’ Table. As shown in FIG. 3A, the database 1 111 consists of data segment 113 and the undo segment 115. Each row in the data segment 113 stores the data of each student and the undo segment is not used while creating the heap record.

When the processing unit 107 receives the INSERT query, it creates a heap record for the predetermined set of data stored in the database 1 111 i.e the processing unit 107 inserts data into the ‘SCHOOL’ Table. The data inserted into the ‘SCHOOL’ Table is referred as new version of the data. The new version of the data is stored in the same data segment 113 of the database 1 111 where the old version of the data is stored as shown in FIG. 3B. Similarly, when the processing unit 107 receives the DELETE query or first type of UPDATE, it creates a heap record, wherein the heap record is stored in the data segment 113 of the one or more databases 111. In an embodiment, when the garbage collector performs the garbage collection operation on the database 1 111, it processes all the rows in the data segment in order to detect and recover the memory space which is not utilized by any application/program.

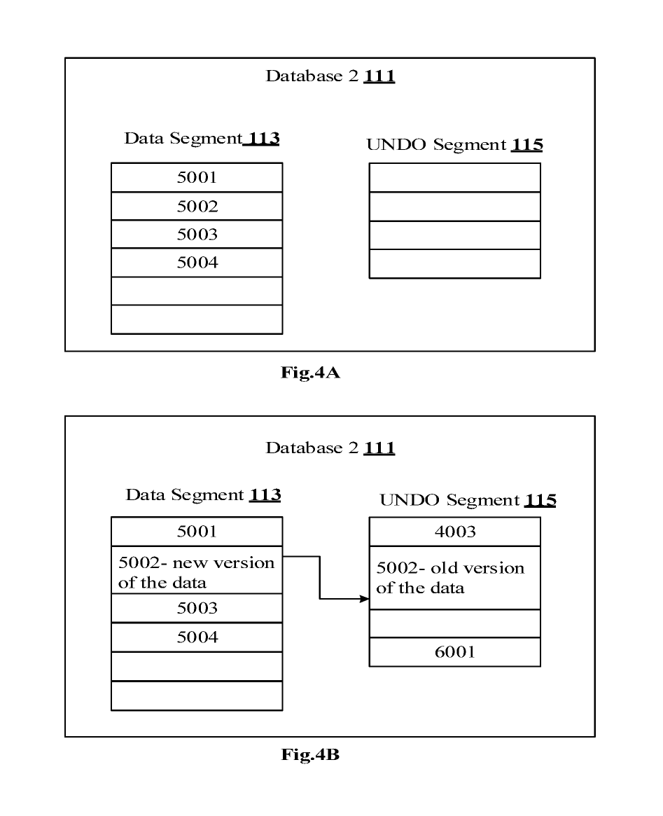

In an embodiment, when the received query is a second type of UPDATE as shown below, the processing unit 107 creates undo record and the undo record is stored in the undo segment 115 of the database. FIGS. 4A-4B shows the block diagram of the database 2 111 in accordance with an exemplary embodiment of the present disclosure. FIG. 4A shows the block diagram of the database 2 111 which stores the information related to the ‘FINANCE’ Table. The database 2 111 consists of the data segment 113 and the undo segment 115. The data related to the ‘FINANCE’ Table is stored in the data segment 113 of the database 2 111 i.e data in each row of the ‘FINANCE’ Table is stored in each row of the data segment 113.
UPDATE FINANCE
SET SUPPLIER_NAME=‘HP’
WHERE NAME=‘BM’;

Upon receiving the query, the processing unit 107 performs the UPDATE operation on the data stored in the ‘FINANCE’ Table i.e the name of the supplier is changed from ‘BM’ to ‘HP’. The updated ‘FINANCE’ Table is as provided below.

TABLE 6
FINANCE

| SUPPLIER_ID | SUPPLIER_NAME | CITY |
|---|---|---|
| 5001 | MS | New York |
| 5002 | HP | Chicago |
| 5003 | RH | Detroit |
| 5004 | NVI | Santa Clara |

The processing unit 107 detects that the memory space occupied by the data after performing the UPDATE operation, which is more than the memory space occupied by the data before performing the UPDATE operation i.e it identifies that the received query is second type of UPDATE. Therefore, the processing unit 107 creates the undo record in the undo segment 115 of the database 2 111. The undo segment 115 stores the old version of the data. The new version of the data is stored in the data segment 113 of the database 2 as shown in the FIG. 4B. In an embodiment, when the garbage collector performs the garbage collection operation on the database 2 111, it processes the rows in the data segment only i.e it processes only the new version of the data stored in the data segment 113. By doing this, the number of rows processed by the garbage collector is reduced.

In an embodiment, if there is a ROLLBACK operation in the received query the processing unit 107 returns the one or more databases 111 to the previous state at which the transaction started. Rollbacks are important for the database integrity, because through this operation the database can be restored to a clean copy even after erroneous operations are performed. They are crucial for recovering from database 111 server crashes. By rolling back, any transaction which was active at the time of the crash, the database is restored to a consistent state. Rollback is nothing but performing the UNDO operation. While performing the UNDO for INSERT/DELETE query is kind of complete reverse operation of actual operation, which might be a costly operation. Therefore, with more number of operations in the same transaction, more number of UNDO and hence more time to do the rollback operation. Hence, the rollback performance goes down. The present disclosure overcomes this problem by creating an undo record for the second type of UPDATE.

When the ROLLBACK operation has to be performed, it has to perform the UNDO of all the operations in a particular transaction. As an example consider ATM transaction. In the ATM transaction the bank stores the information related to the transaction made by each customer in a database in the form of a Table. For this purpose, the Table ‘ATM’ is created and the data related to the transaction are stored in the ‘ATM’ Table.
CREATE TABLE ATM (id INT);
INSERT INTO ATM (id) VALUES (1);
INSERT INTO ATM (id) VALUES (2);
COMMIT;
UPDATE ATM SET id=200 WHERE id=1;
SAVEPOINT id_1upd;
UPDATE ATM SET id=1000 WHERE id=2;
ROLLBACK TO id_1upd;
SELECT id FROM ATM;

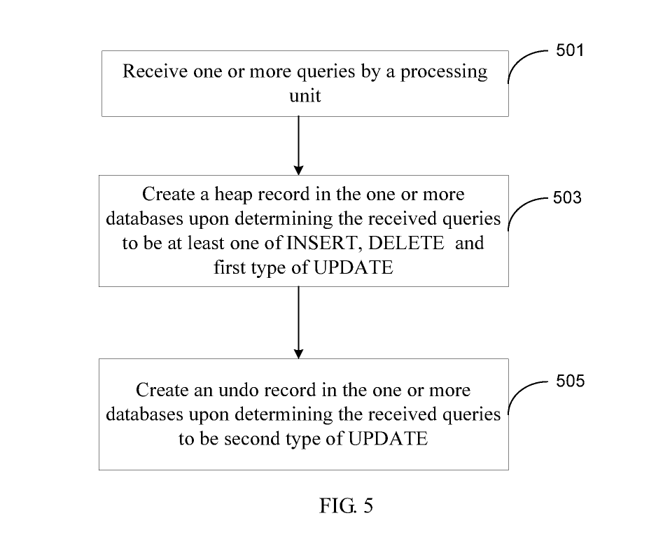

In the above query, there are two INSERT and UPDATE operations. For the INSERT operations, the processing unit 107 creates a heap record and stores the heap record in the data segment 113 of the database 111. The processing unit 107 identifies that the received UPDATE queries are second type of UPDATE operations and therefore creates an undo record and stores the undo record in the undo segment 115 of the database 111. When the ROLLBACK operation has to be performed, it has to perform less number of UNDO since for the second type of UPDATE undo record is created. Therefore, the ROLLBACK has to perform UNDO only for the INSERT DELETE operations. By this number of UNDO are reduces and thus the performance of the ROLLBACK is improved. FIG. 5 shows a flowchart illustrating method for automatic management of dynamically allocated memory in a computing unit 105. At step 501, the processing unit 107 receives one or more queries from the one or more client machines 101. Upon receiving the one or more queries, the processing unit 107 performs one or more operation on the predetermined set of data stored in the one or more databases 111. If the received one or more queries are related to at least one of INSERT, DELETE and first type of UPDATE, the processing unit 107 creates a heap record in the one or more databases 111 at step 503. The heap record is stored in the data segment 113 of the one or more databases 111. At step 505, the processing unit 107 creates the undo record for the one or more queries upon identifying the one or more queries to be second type of UPDATE. The undo record is stored in the undo segment 115 of the one or more databases 111.

The described operations may be implemented as a method, system or article of manufacture using standard programming and/or engineering techniques to produce software, firmware, hardware, or any combination thereof The described operations may be implemented as code maintained in a “non-transitory computer readable medium”, where a processing unit may read and execute the code from the computer readable medium. The processing unit is at least one of a microprocessor and a processor capable of processing and executing the queries. A non-transitory computer readable medium may comprise media such as magnetic storage medium (e.g., hard disk drives, floppy disks, tape, etc.), optical storage (compact disc read-only memories (CD-ROMs), digital versatile discs (DVDs), optical disks, etc.), volatile and non-volatile memory devices (e.g., electrically erasable programmable read-only memories (EEPROMs), read-only memories (ROMs), programmable read-only memories (PROMs), random-access memories (RAMs), dynamic random-access memories (DRAMs), static random-access memories (SRAMs), flash memory, firmware, programmable logic, etc.), etc. The non-transitory computer-readable media comprise all computer-readable media except for a transitory. The code implementing the described operations may further be implemented in hardware logic (e.g., an integrated circuit chip, programmable gate array (PGA), application specific integrated circuit (ASIC), etc.).

Furthermore, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth®, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the disclosure.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Furthermore, operations may be performed by a single processing unit or by distributed processing units.

The foregoing description of various embodiments of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto. The above specification, examples and data provide a complete description of the manufacture and use of the composition of the disclosure. Since many embodiments of the disclosure can be made without departing from the spirit and scope of the disclosure, the disclosure resides in the claims hereinafter appended.

Additionally, advantages of present disclosure are illustrated herein.

Embodiment of the present disclosure provides a method to improve performance of garbage collector by processing less number of rows in the data segment.

Embodiment of the present disclosure provides a method wherein the garbage collector processes less number of heap records due to which less number of I/O operations are required to be performed.

Embodiment of the present disclosure improves performance of garbage collector because of processing less number of rows in the data segment.

In one embodiment, the method disclosed in the present disclosure enables to perform rollback operations quickly as it has to process less number of undo records.

Embodiment of the present disclosure provides faster recovery operation because of less undo records since UNDO will be written only for second type of UPDATE operation.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for automatic management of dynamically allocated memory in a computer, comprising:
receiving one or more queries by a processor, wherein the processor is configured to perform an operation on one or more databases in response to the received one or more queries;
creating, by the processor, a heap record for a predetermined set of data stored in the one or more databases upon determining the received one or more queries to be at least one of INSERT, DELETE and a first type of UPDATE; and
creating, by the processor, an undo record for the predetermined set of data stored in the one or more databases upon determining the received one or more queries to be a second type of UPDATE.

2. The method as claimed in claim 1, wherein the operation performed on the one or more databases is selected from at least one of:
inserting data into the one or more databases;
deleting data from the one or more databases;
retrieving data from the one or more databases; and
updating data in the one or more databases.

3. The method as claimed in claim 1, wherein the heap record is created in a data segment of the one or more databases, and wherein the undo record is created in an undo segment of the one or more databases.

4. The method as claimed in claim 1, wherein the first type of UPDATE modifies the predetermined set of data, and wherein a memory space occupied by the modified predetermined set of data in the one or more databases is same as the memory space occupied by the predetermined set of data.

5. The method as claimed in claim 1, wherein the second type of UPDATE modifies the predetermined set of data, and wherein a memory space occupied by the modified predetermined set of data in the one or more databases is different as compared to the memory space occupied by the predetermined set of data.

6. The method as claimed in claim 1, wherein the one or more queries is generated using structured query language (SQL).

7. The method as claimed in claim 1, wherein the predetermined set of data stored in the one or more databases is related to one or more establishments.

8. The method as claimed in claim 1, wherein the one or more databases are stored in a memory of the computer, and wherein the one or more databases is a relational database.

9. The method as claimed in claim 1, wherein the one or more queries are received by the processor from one or more client machines associated to one or more users.

10. A system for automatic management of dynamically allocated memory in a computer, comprising:
a memory configured to store one or more databases; and
a processor communicatively coupled to the memory being capable of:
receiving one or more queries;
performing an operation on the one or more databases based on the received one or more queries;
creating a heap record for a predetermined set of data stored in the one or more databases upon identifying the received one or more queries to be at least one of INSERT, DELETE and a first type of UPDATE; and
creating an undo record for the predetermined set of data stored in the one or more databases upon identifying the received one or more queries to be a second type of UPDATE.

11. The system as claimed in claim 10, wherein the first type of UPDATE modifies the predetermined set of data, and wherein a memory space occupied by the modified predetermined set of data in the one or more databases is same as the memory space occupied by the predetermined set of data.

12. The system as claimed in claim 10, wherein the second type of UPDATE modifies the predetermined set of data, and wherein a memory space occupied by the modified predetermined set of data in the one or more databases is different as compared to the memory space occupied by the predetermined set of data.

13. The system as claimed in claim 10, wherein the processor being capable of creating the heap record in a data segment of the one or more databases and the undo record in an undo segment of the one or more databases.

14. The system as claimed in claim 10, wherein the one or more databases is a relational database.

15. The system as claimed in claim 10, wherein the processor being capable of receiving the one or more queries from one or more client machines associated to one or more users.

16. The system as claimed in claim 15, wherein the one or more client machines are selected from at least one of a mobile device, contactless device, computer, personal digital assistants (PDA), and any other communication devices capable of performing data transmission and displaying.

17. A non-transitory computer readable medium including operations stored thereon that when processed by at least one processor cause a system to perform the acts of:
receiving one or more queries;
performing an operation on one or more databases stored in a memory, in response to the received one or more queries;
creating a heap record for a predetermined set of data stored in the one or more databases upon determining the received one or more queries to be at least one of INSERT, DELETE and a first type of UPDATE; and
creating an undo record for the predetermined set of data stored in the one or more databases upon determining the received one or more queries to be a second type of UPDATE.
